(19) United States
(12) Patent Application Publication
(10) Pub. No.: US 2008/0177708 A1
(43) Pub. Date: Jul. 24, 2008

(54) System and method for providing persistent, dynamic, navigable and collaborative multi-media information packages

(75) Inventors: Shekar Ayyar, San Jose, CA (US); Rajat Mukherjee, San Jose, CA (US); Stephen C. Rhoads, Hummelstown, PA (US)

Correspondence Address: LAW OFFICE OF DONALD L. WENSKAY, 16909 VIA DE SANTA FE, 200, P.O. BOX 7206, RANCHO SANTA FE, CA, 92057, US

(73) Assignee: Koollage, Inc., San Jose, CA (US)

(21) Appl. No.: 11/982,737

(22) Filed: Nov. 1, 2007

Related U.S. Application Data
(60) Provisional application No. 60/855,613, filed on Nov. 1, 2006.
(60) Provisional application No. 60/855,614, filed on Nov. 1, 2006.

(51) Int. Cl. G06F 17/30

(52) U.S. Cl. 707/3; 707/102; 707/E17.014

(57) ABSTRACT

A system and method is provided for system for collecting, storing, presenting and disseminating information. In one embodiment, a structured file is generated in response to a query comprising a plurality of frames each containing human readable content displayable on a screen, the plurality of frames comprising an object. The system also includes a storage means for storing the object, a means for transferring the object from one location to another, a means for displaying the object and a user interface means for enabling a user to navigate through the object displaying individual frames.

### CROSS REFERENCE TO RELATED APPLICATIONS

The present application claims the benefit of U.S. Provisional Patent Application No. 60/855,613, filed on Nov. 1, 2006 and U.S. Provisional Patent Application No. 60/855,614, filed on Nov. 1, 2006.

### FIELD OF INVENTION

The present invention generally relates to computer implemented techniques for collecting, storing, presenting and disseminating information.

### BACKGROUND

A variety of search engines are in wide use to facilitate searches for information on the Internet. Most search engines present search results as a list of summaries and hyperlinks of websites related to the search. Because the search results are formatted in a list the summaries are limited in the information content they can contain. Likewise, advertisements, appearing above and around the search results only have limited text-only information. While conventional search engines are effective at providing access to information they are not particularly helpful in sorting through and collecting large quantities of search results. The search engine hyperlinks simply direct the user to numerous websites which must be investigated serially to determine their relevance and to collect the information they contain.

Searches on current search engines also are limited to a single media, for example, website text, images and video. Even when searches include various media, they are usually still presented in some flavor of a list view. Searches of website text, images and video are typically conducted as separate and distinct searches with the results presented in a different formats. Website text search results are usually presented as lists of websites, and image and video results presented in the form of thumbnail images. Hence, as a user moves from a website text search to an image search to a video search, even for related subject matter, the user experience is distinctly different and inconsistent and the results are distinct and disconnected. Combining the results from different media would require the user to manually store, sort and assemble the media.

Another shortcoming with conventional search engines is that the results are transient. Users may save the results by bookmarking and indexing the URLs but this is time-consuming and makes collating, organizing and retrieving the information slow and cumbersome. Also, due to the transient nature of search results, current search engines do not facilitate sharing and collaboration among users.

Current search engines are also limited in their ability to comprehend verbose or spoken search requests, requiring users to translate their search requests into keywords, which may not accurately reflect the intended search. Current search engines are also not effective at filtering results to control the relevance of responses and ads. Furthermore, search engines are limited in their ability to package the results in meaningful and useful ways, beyond the presentation of lists. These limitations are partially due to inherent limitation of autonomous machine algorithms in performing certain tasks, such as natural language recognition, image recognition, voice recognition, information classification and semantic analysis, with consistency and high accuracy. Current search engine results and other web-based information are also not structured and presented in an easy to navigate and read manner for mobile platforms with small form factors.

Accordingly, there is a need for systems and methods for improving the collection, storage, presentation, sharing and dissemination of information as well as presenting such information on mobile platforms. There is also a need for systems and methods for improving the user experience with search engines in collecting, storing, presenting, sharing and disseminating information gathered from the internet.

### SUMMARY OF THE INVENTION

To overcome the limitations in the prior art briefly described above, the present invention provides a method, computer program product, and system for collecting, storing, presenting and disseminating information.

In one embodiment of the present invention, a structured file comprises: an information package having a plurality of frames each containing human readable content displayable on a screen; a storage means for storing the object; a means for transferring the object from one location to another; a means for displaying the object; and a user interface means for enabling a user to navigate between individual ones of the frames.

In another embodiment of the present invention, a search engine method comprises: generating a plurality of frames of information in response to a single search request by a user; and packaging the frames into an object that is navigable by the user.

In a further embodiment of the present invention a method of organizing and displaying data comprises: generating a package of information containing a plurality of frames, wherein each frame contains human readable information and wherein the frames contains a user interface to enable a user to navigate between the frames; sending the package of information to a recipient; and displaying the frames by the recipient.

Various advantages and features of novelty, which characterize the present invention, are pointed out with particularity in the claims annexed hereto and form a part hereof. However, for a better understanding of the invention and its advantages, reference should be make to the accompanying descriptive matter together with the corresponding drawings which form a further part hereof, in which there is described and illustrated specific examples in accordance with the present invention.

### BRIEF DESCRIPTION OF THE DRAWINGS

The present invention is described in conjunction with the appended drawings, where like reference numbers denote the same element throughout the set of drawings:

FIG. 1 shows a conceptual diagram of a pod in accordance with one embodiment of the invention;

FIG. 2 shows an example of a request made to a search engine incorporating the techniques of the present invention;

FIG. 3 shows a first frame of a results package resulting from the request shown in FIG. 2 in one embodiment of the invention, showing a single enhanced summary for a given result;

FIG. 4 shows a second frame of a results package resulting from the request shown in FIG. 2 in one embodiment of the invention, showing a set of relevant images;

FIG. 5 shows a third frame of a results package resulting from the request shown in FIG. 2 in one embodiment of the invention, showing an image and summary (table of contents);

FIG. 6 shows a fourth frame of a results package resulting from the request shown in FIG. 2 in one embodiment of the invention, showing a video;

FIG. 7 shows a result frame template for a results package resulting from the request shown in FIG. 2 in one embodiment of the invention;

FIG. 8 shows the updating of a search pod showing that there could be an initial result, which can update over time automatically or due to user intervention, in accordance with one embodiment of the invention;

FIG. 9 shows a web frame page of a search result pod in accordance with one embodiment of the invention;

FIG. 10 shows an image frame page of a search result pod in accordance with one embodiment of the invention;

FIG. 11 shows a video frame page of a search result pod in accordance with one embodiment of the invention;

FIG. 12 shows a diagram of a user search experience using a persistent search with agents in accordance with one embodiment of the invention;

FIG. 13 shows the flow of a request to agents and the result delivery in accordance with one embodiment of a persistent search with agents in accordance with one embodiment of the invention;

FIG. 14 shows a system architecture of a persistent search system with agents in accordance with one embodiment of the invention;

FIG. 15 shows a conceptual diagram of an immediate search without agents used in one mode of the persistent search system with agents shown in FIG. 14 in accordance with one embodiment of the invention;

FIG. 16 shows a conceptual diagram of a search with agents used in one mode of the persistent search system with agents shown in FIG. 14 in accordance with one embodiment of the invention;

FIG. 17 shows a conceptual diagram of an advertising enhancement used in one mode of the persistent search system with agents shown in FIG. 14 in accordance with one embodiment of the invention;

FIG. 18 shows a conceptual diagram of a the coordination of agents and algorithms used in the persistent search system with agents shown in FIG. 14 in accordance with one embodiment of the invention;

FIG. 19 shows a conceptual diagram of algorithmic processing for agent support in the persistent search system with agents shown in FIG. 14 in accordance with one embodiment of the invention;

FIG. 20 shows an exemplary screen of an example request list used by an agent in the persistent search system with agents shown in FIG. 14 in accordance with one embodiment of the invention;

FIG. 21 shows an exemplary screen of an agent search tool in the persistent search system with agents shown in FIG. 14 in accordance with one embodiment of the invention;

FIG. 22 shows an exemplary screen of an agent edit tool in the persistent search system with agents shown in FIG. 14 in accordance with one embodiment of the invention;

FIG. 23 shows an exemplary screen of an agent search tool in the persistent search system with agents shown in FIG. 14 in accordance with one embodiment of the invention;

FIG. 24 shows another exemplary screen showing a results package of the agent search tool shown in FIG. 23 in accordance with one embodiment of the invention;

FIG. 25 is a high level block diagram showing an information processing system useful for implementing embodiments of the present invention;

FIG. 26 shows an exemplary screen display on a mobile device illustrating a home page of a pod in accordance with an embodiment of the invention; and

FIG. 27 shows an exemplary screen display on a mobile device illustrating an index page of a pod in accordance with an embodiment of the invention.

### DETAILED DESCRIPTION OF THE INVENTION

The present invention overcomes the problems associated with the prior art by teaching a system, computer program product, and method for collecting, storing, presenting and disseminating information. Embodiments of the invention provide persistent, dynamic, navigable and collaborative multi-media packages of information, also referred to as pods. The pods may be multi-modal, that is, they may be delivered to different formats, such as computers, wireless devices, cell phones, televisions, etc. Pods may be multimedia, containing different portions, also referred to as frames, in different media such as text, web page, audio, image, video, etc. Pods may also contain advertising. Because pods are long-lived, they may change over time, with frames being added or deleted dynamically (automatically or via user intervention). Pods can be shared and manipulated by users to provide a collaborative information platform. Pods may be syndicated (as RSS feeds) or embedded in other websites or blogs.

In various embodiments of the invention, the content in a pod may be derived from different sources. The frames comprising a pod may be provided in response to a search request to a search engine; may be constructed from text image, audio, video content uploaded and edited by a user; may be constructed and edited from internet feeds, such as RSS, atom, blog feeds and others; may originate as blog posts authored by a user and may include contributions from multiple people thereby creating a social multimedia blog; may be created as an advertisement; or may comprise some combination of the above, or other sources.

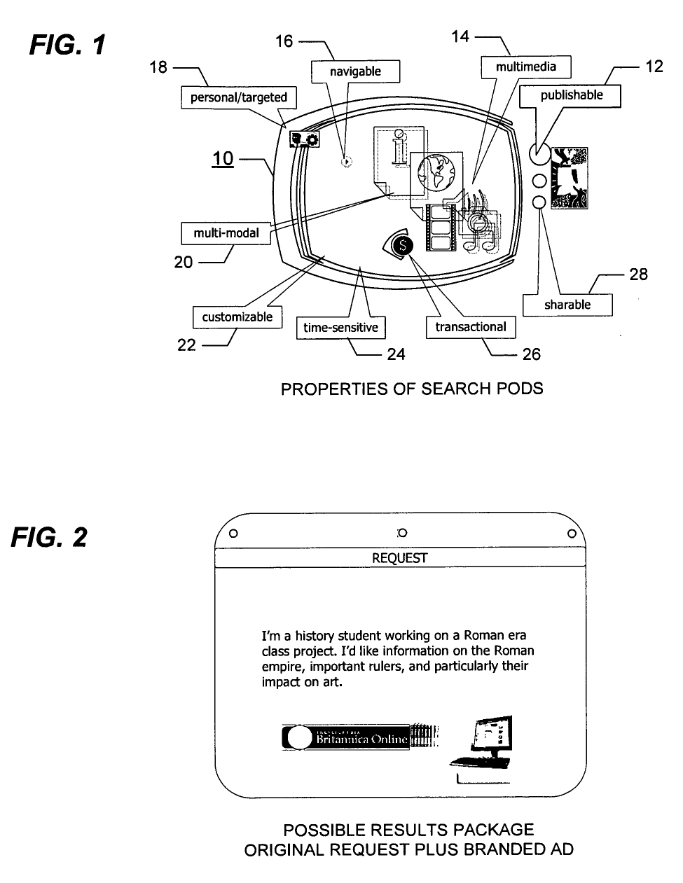

FIG. 1 shows a conceptual diagram of a pod 10, which may be used in various embodiments of the invention. A sampling of the properties that a pod 10 may incorporate is illustrated in FIG. 1. The pod 10 may be publishable 12, meaning that it may be published by a publishing source, such as a newspaper or individual, or a blog and may be manually or automatically updated by means of internet feeds such as RSS or other feeds. Publishers may use the pod infrastructure to directly publish their information to users. The pod may be multimedia 14 to include various media including text, audio, images, video and other media. For example, a single search result pod can contain web results, web page results can contain preview images and enhanced summaries, image frames can have images with summaries and additional metadata, and video frames can play in-line. Audio can play in the background when the pod is being “played”, but optionally not when individual frames are being viewed.

The navigable property 16 indicates that the pod may be “playable”, meaning that a user may be able navigate through the various frames, with controls such as play, pause, forward, reverse as with conventional media players. Navigation may also be facilitated by icons used to access an index of the frames and a home icon to return to the first frame.

Another property of pods is that they nay be personal and targeted 18. Pods can be personalized to specific users—this could be customization, based on color and theme (skin) preferences, or even based on the user's persona or profile, i.e., search results based on implicit preferences of the user. Pods may (optionally) explicitly identify the user who created or edited the pod, or may be anonymous. For example, based on a given user's profile or preferences, a pod for a user may contain news from one source, such as the BBC or from a different source such as CNN. Also, advertisements may be targeted to a user's profile. Advertisements are not restricted to be text-only. This allows for ads to be in-line with the frame content at appropriate points in the “pod presentation”. Branded advertisements, audio, video (including repurposed television commercials) and image advertisements, as well as text-based advertisements can be created in-line to provide a comprehensive experience that is also useful to the user. In search applications, this provides for various means for advertising beyond the short snippets of text advertisements provided on standard web search results. The advertisements can be targeted to the content of the pod, but branding can optionally be independent of the pod content.

Pods may also be multi-modal 20. Hence, the same pod can be delivered to a device other than a web browser, e.g., a cell phone. This may be done in different ways, e.g., as a set of web-based frames, or a video transport. The same pod can be viewed in different ways, and can self-display differently for different devices and form factors. A server sending the pod may utilize an auto detection function, and based on the nature of the client, modify the pod characteristics, such as aspect ratio, etc., to tailor it to the particular client. This can happen through various ways, for example by automatic use of alternate templates for use with different modes, e.g., non-text templates for televisions or PDAs for certain types of data. Alternatively, this may be done by use of alternate data or metadata for display, depending on the mode, e.g., short summaries for cell phones, longer summaries for web browser display. For smaller screens in a search application, a one result per frame paradigm may be well suited.

The property of customizable 22 likewise allows pods to be modified to particular client types as well as profiles of the user. In addition to the customizing of the content based on a user profile, as discussed above (personal/targeted 18), the style and appearance, format, particular media in the frames, etc. of the pod may be customized to a particular user. Further, subsets of frames and particular skins can be delivered to specific users based on privileges or detected relevance.

With the time-sensitive property 24 pods may be automatically updated, for example, with current news relating to the subject matter of the pod. The transactional property 26 indicates that a pod may be used to conduct and facilitate transactions. For example, the pod may be created and send by a merchant and the pod may contain the order form and capability of allowing a user to place orders for products using the pod. In other transactional uses a pod may contain content, such as a book or a movie that may be purchased by a user. The pod infrastructure offers a direct mode of passing targeted information packages, e.g. travel deals, mortgage offers, and product transactions between users. The sharable 28 property indicates that the pod may be shared with others. For example, a pod may contain a user's blog and this blog pod may be shared and added to by others. A pod may become a social blog. That is, a blog exportable as a feed (RSS or XML) representing identifiable collaboration among multiple human users or agents.

FIGS. 2-11 show an exemplary embodiment where a pod is initially created in response to a search request to a search engine. Those skilled in the art will appreciate that the teachings of this embodiment may be readily adapted to the other embodiments and uses, including but not limited to those described above. In particular, FIGS. 2-11 show embodiments for presenting search results in which results sets can be persistent, dynamic and sharable across sets of users, making a unique and collaborative search platform. These embodiments describe the various ways in which users interacting with, manipulate, share and collaborate via the invention's unique search results packaging infrastructure.

Each search result appears as a single frame in a packaged collection of frames (referred to as a result pod). Real-estate issues that affect current list-based search engine presentation are eliminated. Results can be multimodal, so each frame of the pod can be different, e.g., audio, video, web page, image, etc., and can also include multi-media advertising in-line so that a single (potentially complex) search request can provide a single, comprehensive and consistent user experience via a multi-media package. Packages are also persistent and long-lived. Not only can users return to the result package over time, but the package can also change over time, with frames being added or deleted dynamically (automatically or via user intervention).

As a result, the user's search experience is richer and dramatically different. A user can scroll forward and back through the result frames in a pod. The user can “play” the pod much like frames of a television program. Audio (music/dialogue) can be played during the playing of a pod, allowing for a rich multimedia experience. Once a user has created a pod, the user can then share the pod with a predetermined set of users. Multiple users can then collaborate on these packages of information, for example, for work-related projects, school projects, or for entertainment subjects, such as celebrity fan packages, social blogs, or others.

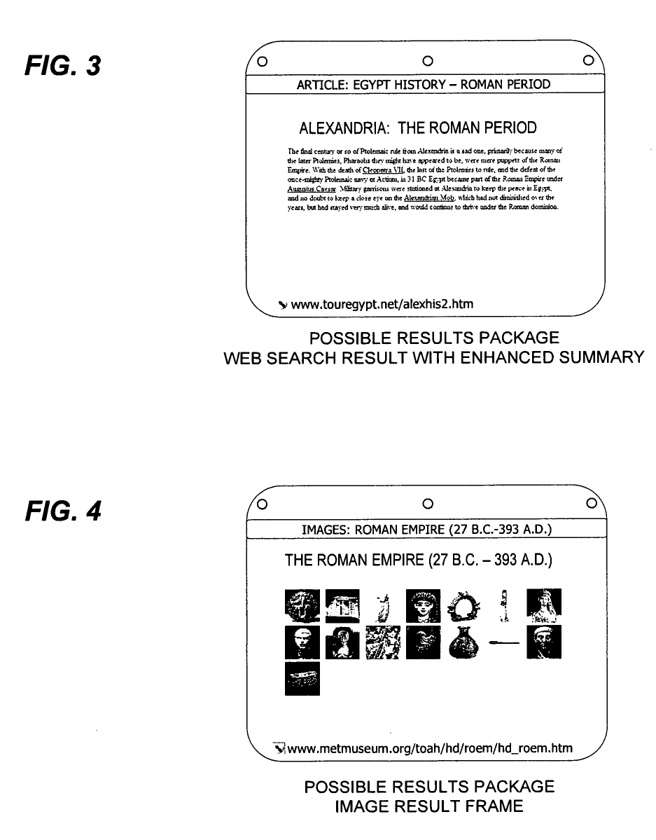

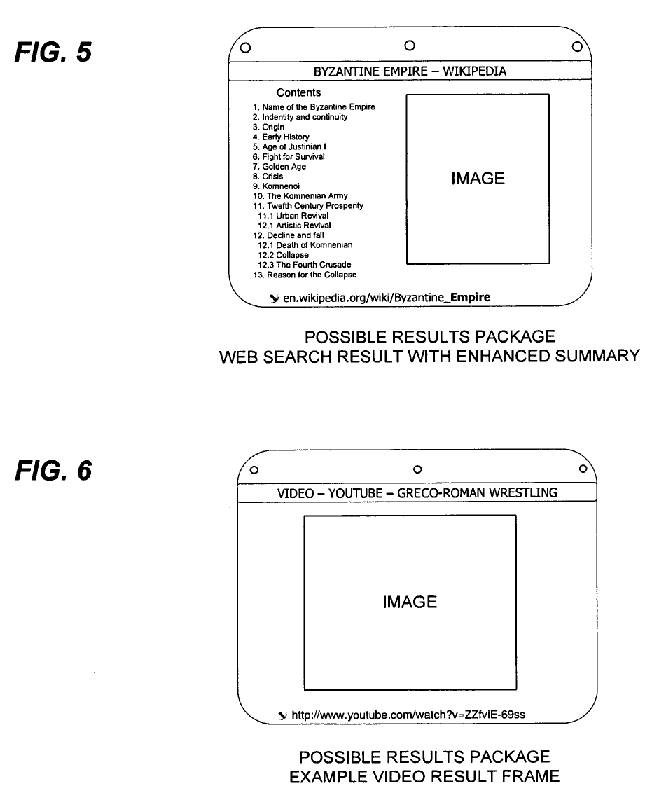

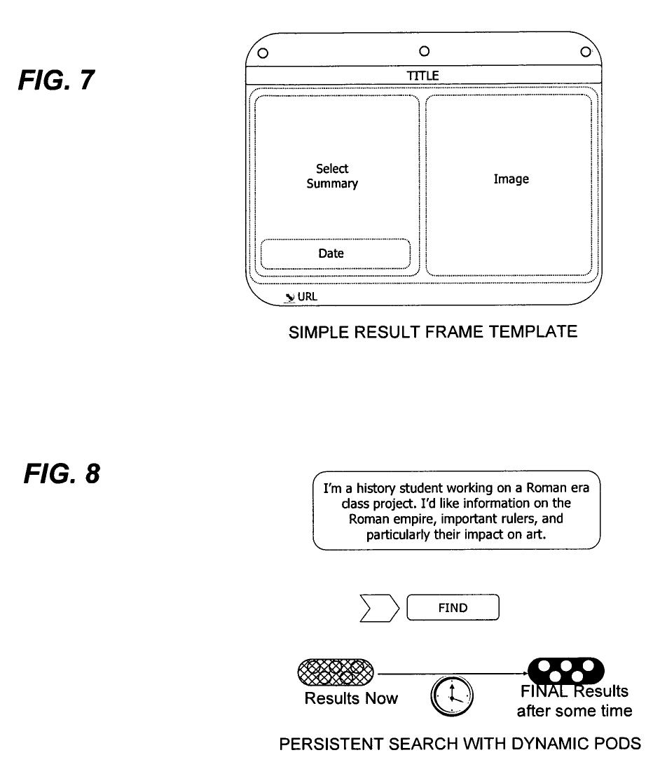

FIGS. 2-6 show details of the user's experience with a pod created by an embodiment of the invention used as a search engine. This is an exemplary embodiment only and various other types of content can be included in the pod. For a single search request, the pod contains a collection of frames of information. Each frame usually represents a single result, but it is possible for a single result item to be represented by multiple frames, or for multiple results to be packed into a single frame of the pod, e.g., a collection of images. FIG. 2 shows, in one embodiment, the request itself, including a branded advertisement (Encyclopedia Britannica) in-line with the frame. FIG. 3 shows web result page comprising an article related to the search request. FIG. 4 shows an image result page, which may be from a web page or generated via an image search. FIG. 5 shows a more comprehensive web search result with enhanced summary/table of contents plus an image. FIG. 6 shows a video result from the request obtained from a video search service, such as You Tube. Each frame can be governed by a template, such as the example shown in FIG. 7, which may also be a default template for a web search result. Other templates that may be used include:
a stock-ticker template that shows a dynamically updating stock chart
a video template that is full screen video
audio template (which could be a “hidden” template)
image template(s) that contains multiple images in a table
photo album template
a map template
directions template
PowerPoint template that actually creates a Microsoft PowerPoint presentation
PDF template that generates an Adobe PDF document for delivery
Term-Paper template
Person Information template, e.g., summary before business meeting
A “company report” template that contains elements of desired information.
standard results list template (could be another instance of a “hidden” template)
Subjective opinion template (e.g., input from a newsgroup, forum or other social service, e.g., Yahoo! Answers)
Metadata template e.g., a frame with metadata, e.g., date, classification, and tags about a page that are algorithmically constructed (concepts identified on the page), or from an external service, e.g., digg, del.icio.us, etc.
   Other embodiments of this invention can use other predefined templates for presentation.

A search pod A search pod can be persistent. The initial request is contained within the pod, and the search results are packaged into an object that can be visited at a later time. A search pod can be dynamic. An immediate (machine computed result) pod can be delivered to the user immediately when the search is performed (synchronously), and can then be followed by enhanced search results that are dynamically added to the pod. This enhancement of the pod over time can be performed either by enhanced algorithms, or humans (the user, his/her friends, or other designated search agents), or a combination of both.

FIG. 8 shows how the user's search pod can change over time, for example, getting updated with more recent information, or by users adding more relevant information to the pod over time, such as a news frame that auto updates, or an RSS or feed based pod that refreshes automatically.

As a result of this dynamic search model, where the user's information pack gets better over time, and (optionally), a lifetime is associated with the request, or with specific results/frames of the pod. For example, the frame for a product offer that is good until a given time can automatically “expire” and not be displayed in the pod after that time has passed (in this case, based on the metadata in the “date” field).

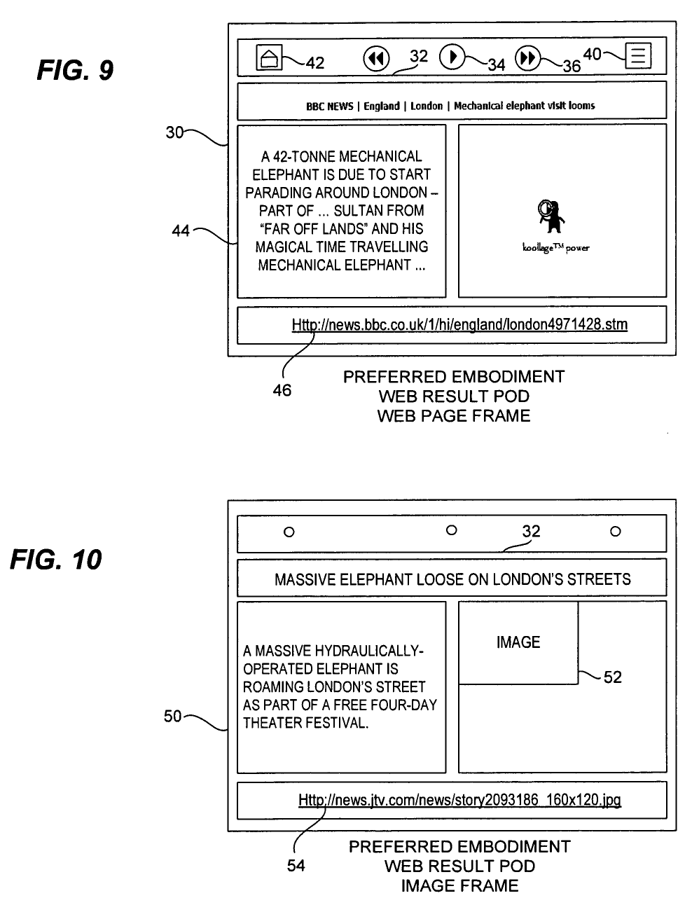

FIG. 9 shows an exemplary web page frame 30 of a pod that is generated as a result of a search in accordance with an embodiment of the invention. A navigation bar 32 contains buttons for navigating through the frames of the pod. These include a play/pause button 34, forward button 36, back button 38, index button 40 (navigating the user to an index frame listing all of the frames in the pod) and a home button 42 (returning the user to the first frame of the pod). A text excerpt 44 from a web page is in the box on the left and the URL 46 of the web page shown in the frame is at the bottoms of the frame.

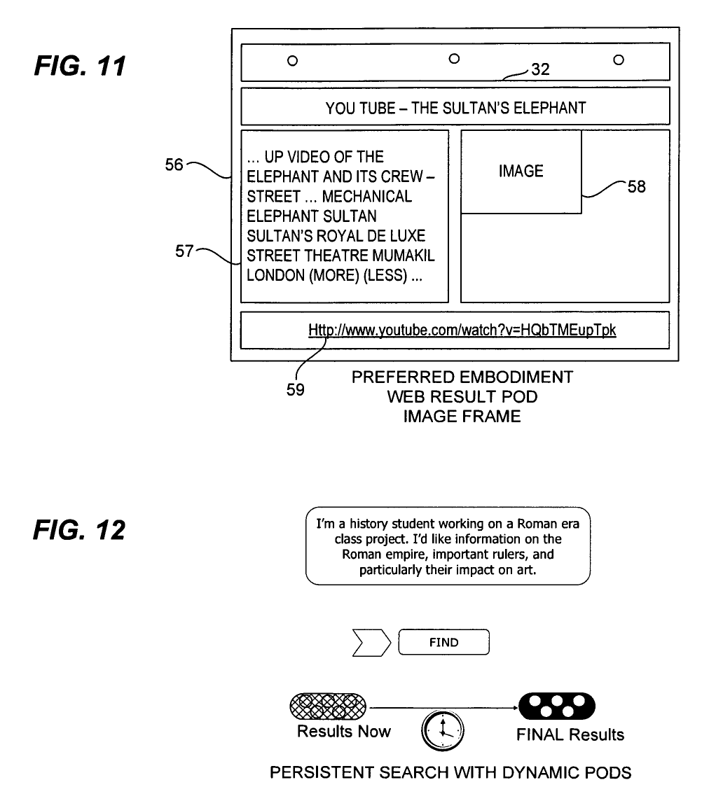

FIG. 10 shows an image frame 48 of a web result pod generated as a result of a search in accordance with an embodiment of the invention. An excerpt of the text 50 from a web page appears on the left and an image 52 from the web page appears on the right. The navigation bar 32 is the same as in FIG. 9. The URL 54 of source of the image appears at the bottom. FIG. 11 shows a video frame 56 of a web result pod generated as a result of a search in accordance with an embodiment of the invention. A portion of the text 57 of a website appears on the left and a video 58 appears on the right. The URL 59 of the web site appears at the bottom.

FIG. 26 shows a home page screen of a pod displayed on a mobile device such as a cell phone in accordance with an embodiment of the invention. FIG. 27 shows an index screen of a pod displayed on a mobile device such as a cell phone.

In accordance various aspects of the invention embodiments may have a number of characteristics including:
1. Pods can be persistent and representable via a structured file format. A preferred embodiment is to use a variant of RSS (Really Simple Syndication), or Atom, or mRSS (Media RSS), such as version with an expanded namespace (using XMLnamespaces).
2. Pods can be uniquely referenced via Universal Resource Locators (URLs), accessible via the Internet through a browser.
3. Pods are fully searchable.
4. Pods can be “owned” by specific users.
5. Pods can be personalized and customized. Users can provide “skins” for their pods, e.g., a Dallas Cowboys fan can have a pod that always shows the team colors and possibly specific frames of information, e.g., the latest record/scores, team photo(s) etc.
6. Pods can be edited, deleted, emailed and passed around via instant messages.
7. Pods can be further packaged along with resources into self-contained resource packages, e.g., video streams, zip files, etc. This is distinctly different from the regular pods, which only represent search results (with summaries, snippets, thumbnails, etc.). This is an option for mobile devices or off-line browsing of the pod.
8. Pods can optionally have history recorded of all the changes the pod has undergone.
9. Pods can optionally have versioning enabled so multiple versions of the pod are available.
10. Pods can include encrypted user financial information, e.g., bank, credit card, eBay Paypal, Google Checkout account information.
11. Pods can be encrypted and require passwords or other keys to access/view.
12. Pods can include encrypted product transactional information, e.g., Paypal account information, prices, rebates, etc.
13. Pods can include coupons and other offers.
14. Users can communicate with others via special frames in the pod. This allows for direct collaboration between users in real-time or near real-time.
15. Pods can have (visual or query-able) status flags associated with them for inspection and rules to be applied to them, e.g., send a message to a user A when the pod goes to “DONE” state. A visual flag associated with the pod can then change from “orange” to “green”. This is just one example of preferred embodiment.
16. Pods can be built from feeds ((RSS, Atom, other XML feeds, etc.) and can automatically update when the source feeds change.
17. Pods can be built by multiple people in a shared manner to create shared social blogs that can also be syndicated as RSS.

In accordance with various aspects of the invention frames may have a number of characteristics including:
1. Frames can be built from templates, e.g., web, video, image, finance, health, stock quote, product review, etc.
2. One frame can represent a single search result or web resource, or a portion of the result, or multiple results
3. Multiple frames can represent a single search result or web resource.
4. Frames will include references to original sources of information, and this could be (optionally) added to an index at the end of the pod.
5. Frames can hide or show specific information on demand, e.g., URL, date, etc.
6. Frames can be “typed”, categorized, and color coded for ease of navigation
7. Navigation can include types, categories and additional icons for ease of navigation through sections of the pod.
8. Frames can expire automatically based on specific conditions around frame metadata or content, e.g., expired dates, or other rules, e.g., price outside a given range. These frames can be optionally converted to hidden frames or deleted automatically.
9. Frames can be hidden or implicit. Examples are audio frames (audio plays, but metadata frame is made available on demand, e.g., shortcut key) or search result list frame (the total set of search results presented in the pod, provided on demand as a list for research)
10. Frames can be manually deleted and moved within pods, based on permissions.
11. Individual frames can be edited via frame editing tools provided by the system, e.g., summaries can be updated by selection of additional sentences, Images can be replaced, etc.
12. Frames can include advertisements (textual and non-textual/multi-media)
13. Frames can be offers, coupons or special deals or rebates
14. Frames can have encrypted hidden information, such as userids, passwords, keys, account numbers, etc.
15. Frames can be used for communications and messages between users, and for scratch space.
16. A frame added by a user in a shared pod can be identified as being authored by that user.

In accordance with various aspects of the invention, pads may have an number of sharing, interactive and collaborative functions including:
1. Pods can be shared by user A with user B, by simple addition of user “B” to the pod
2. Pods can be shared by user A with a group G (multiple users in group G) by addition of group “G” to the pod
3. Group G can automatically have other users added to it independent of the pods shared.
4. Pod A can have a workflow associated with it—e.g., shared by user “B” after 2 days, and then shared by user “C” after 4 days. Other more complex rules and workflows can be created around pods for automatic processing of pods.
5. Multiple users who are sharing a pod can update it with frames.
6. Any number of pods can be collapsed into new pod for sharing
7. Pods or parts of pods can be encrypted for sharing with secret passwords that users can pass to each other
8. User flow can be added to pods, with specific triggers and actions, that will cause automatic routing of pods to specific users, e.g., send pod P to user B after 2 days.
9. Interactive and multiplayer games can be hidden, embedded in pods, with token collection, prizes, etc. upon completion by a group of users
10. Discoverable utilities/surprises in pods, e.g., currency converters for travel pods, calculators for math pods, mortgage calculators for refinancing pods, portfolio tools for stock pods.
11. Pods can show automatic affinity across related pods for information discovery and community creation, causing pods to be revisited and sticky. Various technologies for recommendation and affinity can be deployed to make affinity more targeted, including user profiles and other user/pod context.
12. Special queries can trigger special pod behavior and prizes, special offers, etc.
13. Pods can have special offers included for specific users or specific topics, or just to make pods more interesting to users.
14. Pods can morph from skin to skin (theme to theme) as they get transferred across users, without the content actually changing. Templates could change the presentation as this “morphing” happens.

It will be appreciated that the pods as described in connection with FIGS. 1-11 may be implemented using readily available tools. For example, these may include such tools as AJAX, Java Script, and Asynchronous Java. In particular, it is possible to use Javascript, using AJAX technology and asynchronous calls to the server system to be able to prefetch frames so that navigation becomes seamless. This does not require any special software downloads. On the other hand, other software such as plugins, or Java classes/applets, or flash technology or other related client technologies can also be adopted to perform the dynamic navigation, edit, collaboration and navigation functions. Those skilled in the art will realize that the asynchronous behavior of the system allows the latency of server interactions to be hidden from the user who is interacting with the pod, allowing a seamless experience

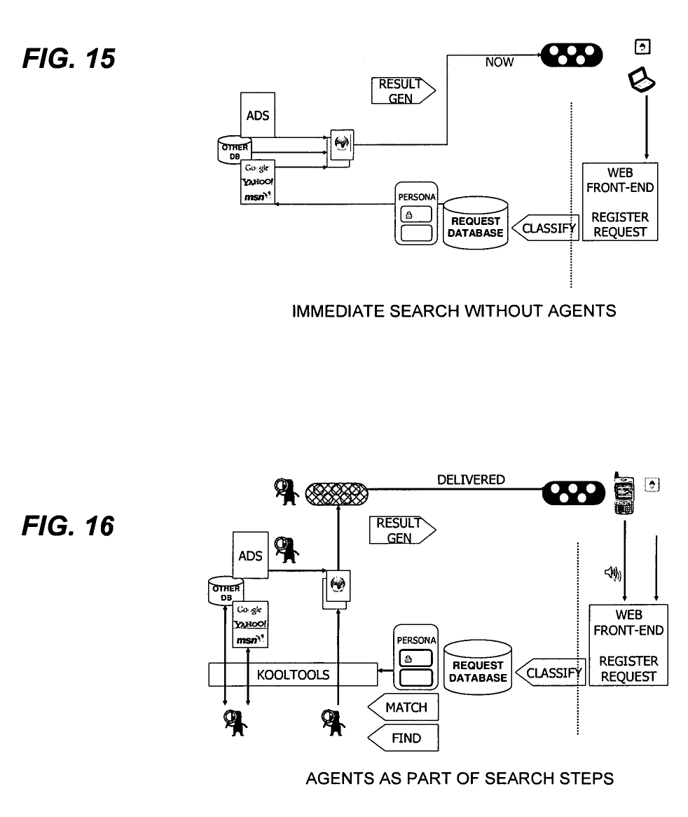

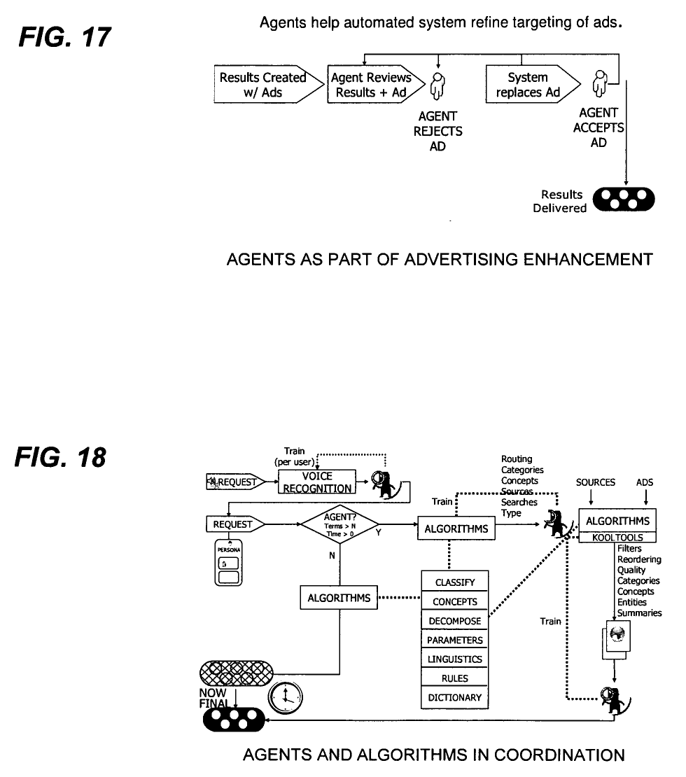

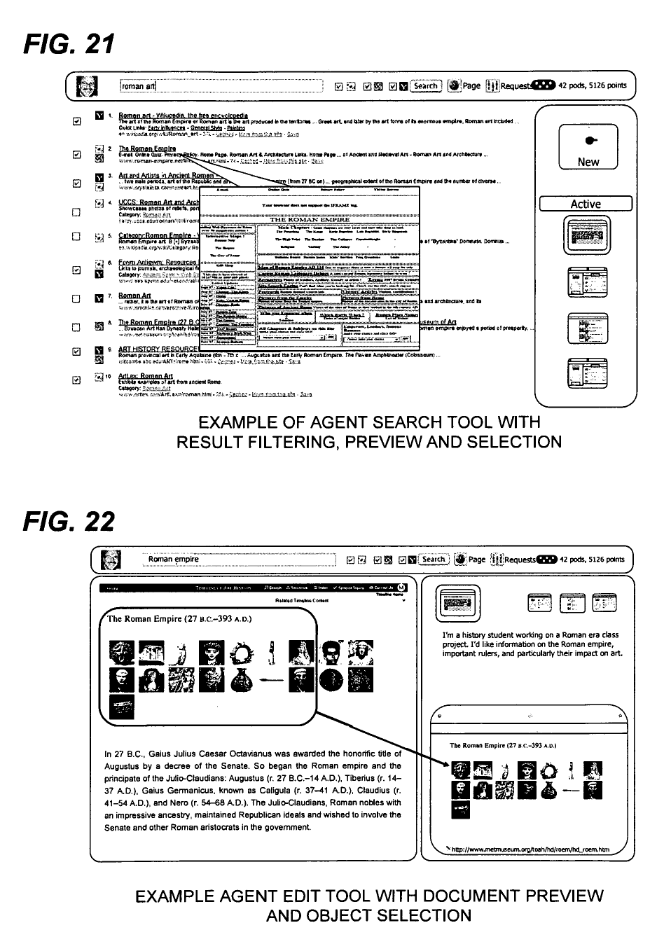

FIGS. 12-24 show additional embodiments of the present invention incorporating a system and method for incorporating human insight into search results. The injection of human intelligence into the search process significantly improves the comprehension of the incoming search request, the filtering and selection of results, as well as the final preparation of the results to the user who made the request. Further, the user community itself can be involved in this human manipulation m, or this function can be provided by a group of “agents”, whose sole responsibility is to review requests (text, SMS message, audio or video, etc.), use a set of intelligent search-enabled tools and algorithms to filter, review and select results, and finally package the results for consumption in a user-friendly fashion. The search system and method shown in FIGS. 12-24 may or may not be used with the above-described pods shown in FIGS. 1-11.

Other approaches to date have used machine algorithms to solve the search problem. Human involvement has been generally off-line training of machine algorithms, or creating preset search results for specific queries. The present embodiment is a system and process in which human intelligence is injected into the on-line search process, allowing humans to directly influence the live search process and the quality of results. These embodiments include the algorithm-aided tools to effectively and rapidly enhance both search results and advertisements to enhance the user's experience.

The present embodiments includes a system that selectively injects human intelligence in tight collaboration with sophisticated technology to enable improvement in key steps in the search process. The user's search experience is dramatically improved, due to improvement in the following areas: 1) comprehension of the request; 2) construction/enhancement of search results via the use of tools; and 3) better packaging and presentation.

FIG. 12 shows the user's experience, where an immediate (machine computed result) can be delivered first to the user, followed by an enhanced search results pack, which can be altered over time either by enhanced algorithms, or human agents, or a combination of both. This allows for a persistent search model, where the user's information pack gets better over time, and a lifetime is associated with the request. Note that this is just one possible experience and other variations of the experience can be devised as alternate instantiations of the invention, e.g., delivery of results to other devices over time, etc.

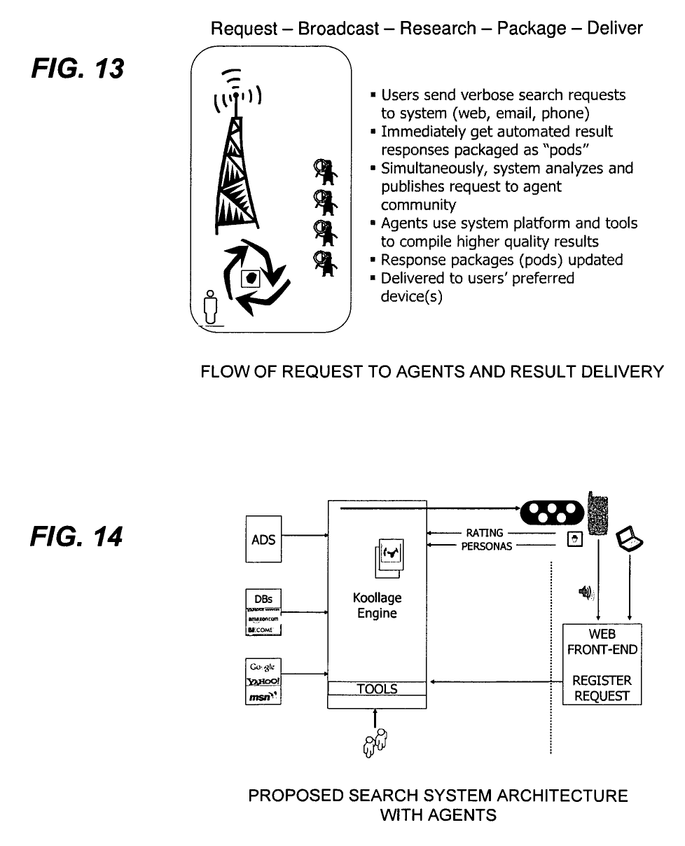

FIG. 13 shows an embodiment of the flow of requests to agents, and enhanced results being delivered to the users in an asynchronous manner. Other workflows can be conceived in alternate embodiments of the invention, where there are multiple points of communications between users and agents.

FIGS. 14-17 show the architecture of the system, along with the flow of information, and where humans (agents) get involved in the search process, including oversight of search advertisements. Note that other variations of the architecture are possible. Tools refer to the agent tools that are enhanced with technology algorithms for keyword extraction, concept extraction, machine classification, data filtering and re-ranking, snippet selection and summarization, as well as result manipulation.

Various embodiments of the invention may include the following aspects of this system and flow of information:
1. Input requests can be in text, SMS messages, voice (audio), or video, or any other reasonable multimedia format, including posted documents or voicemail/phone mail.
2. Input requests can be verbose and in any natural language, as it is possible for a human to interpret the request better than a machine algorithm. It is possible to couple machine intelligence and training to help the human be more efficient and accurate. Thus, voice recognition, or other semantic natural language models can be trained automatically over time with a user's requests, since they can be identified uniquely via phone source information, etc.
3. Sources can be proposed automatically by algorithms that use combinations of rules and automatic machine classification of the request text. Agents can override or filter the proposed sources in order to provide comprehensive result sets. Example search sources can include existing or proprietary search engines, online databases, web services, online stores, yellow pages, mapping services, local services, phone services, as well as other public or proprietary sources of information.
4. Search tools are provided for the human agents that allow the agents to quickly and efficiently search the different sources of information, with suggested queries and concepts. The agents can use the suggested queries and concepts for finding results, or use their own specific judgment, or a combination of these to find appropriate results for the request. The original request is available at all points in the process.
5. Search tools allow the agent to filter and reorder the results, and allow the agent to add specific results to the result set. (again, via a combination of automated suggestions and human selection)
6. Search tools and other advertising tools can be available to the agent to help decide on rejecting advertisements in order to make advertisements more relevant to the request.
7. Summaries are also proposed, based on search engine snippets, as well as sentence suggestions based on concepts detected in the selected result documents. Again, agents can create combined summaries from all these suggestions, thereby crafting a much more relevant summary of the document than just an algorithm alone.
8. The agent also has control over the final presentation of the results, including using pre-defined templates for specific classes/types of information, e.g., finance, product, research, etc., and creates a package of information that can then be delivered to the user, again via various devices, e.g., web, phone, cell phone, video, etc.
9. The user's persona (or profile) can be used along with the original request. Specifically, certain public portions (allowed explicitly by the user) can be viewed/used/exposed to the agents, while specific private/secure portions of the profile/persona can only be used by/exposed to the machine algorithms, providing privacy to the user while providing more context for the request for the agent to use better judgment.
10. Agents can share results, searches and packages with other agents. Multiple agents can work in parallel or collectively on a single request.
11. Agents can be rated based on the user's satisfaction with the results. Ratings can be aggregated in various ways to provide a quality measure of the agent's work.
12. Agents can be generalists (all areas of interest), or specialists (e.g., experts in special field, e.g., medical). Requests can be routed automatically to specific agents based on there area of interest, explicitly or implicitly. For example, as an agent continues to provide high quality results in a certain category, he/she automatically is marked as an “expert” in that category, and future requests in the category can be automatically routed to him/her with higher probability.
13. Users can rate the quality of the results, and these ratings can impact the future selection of the agents. Agents can be automatically promoted to be specialized based on categories of requests and ratings of result packages.
14. System can allow for communication between the agent and the user, if required. It is possible for the package itself to contain enough metadata to enable this communication.
15. Agents can communicate with each other.
16. Agents can reject requests.
17. Agents can route requests to other agents as part of a larger workflow. Agents can correct algorithm-proposed tags, concepts, categories, or other suggestions and submit requests back into the request pool for re-routing to other agents, or other action.

FIG. 18 shows technology aids provided to agents in the flow of information used in various embodiments of the invention. FIG. 18 also shows the various technology algorithms that work in the process at different stages, as well as some points of interaction between the agents and the technology platform.

Sample steps in an embodiment of the invention are:
1. Verbose Request arrives at the system. This request can be optionally coupled with a user persona (profile), explicitly or implicitly.
2. If request is a voice request, voice recognition can be used along with an agent who can quickly listen to the request and validate the machine-recognized verbose request.
   a. Over time, a user's voice model can be trained automatically via multiple requests associated with the user, e.g., via the user's phone number.
3. Request can be automatically categorized into determining if the request needs to go to an agent at all. If voice, this step may have already occurred, since an agent may access it anyway.
4. If an agent is not required, the request may be directly answered using automatic means, e.g., via a search algorithm, or delegation to a search engine. Analysis of the request is required to create a search result.
5. If an agent is required, the request is analyzed further for routing to a set of agents for the determined topic or concepts.
6. Request shows up in a public queue or an agent's queue (or more agents, in an alternate embodiment)
7. An agent can reject the request, or accept it, or correct any classifications or concepts assigned to the request and forward it to other agents directly or via insertion into the pool.
   a. Based on the agent interaction, the classification model, or concept selection can be automatically updated (training)
8. Once accepted, the agent can manipulate the result set via rejecting certain results, or starting from scratch.
9. The machine algorithms may suggest specific sources of information that the agent can use to perform specific lookups/searches for addition to the result set. Some of these sources may be proprietary sources available to the user, or being promoted to all users (via summaries, titles and snippets) via the publisher. Any type of online information source can be suggested or explicitly selected by the agent.
   a. Based on the acceptance of the sources proposed to the agent, the source selection algorithm can be updated automatically (training)
10. The machine algorithms may suggest specific searches that the agent can perform to select alternate results for addition to the result set.
   a. Based on the searches selected by the agent, the search query dictionaries and search proposal algorithms can be updated automatically (training/learning)
11. Portions of the user persona, e.g., the public portion, may be visible to the agent, while private portions may directly be applied to subsequent searches performed by the agent.
12. Machine algorithms for re-ranking or further filtering of results, based on result quality, can be used to reduce or refine the results of every search performed by the agent. Various heuristics can be used to determine result quality.
   a. Each agent rejection can be used to update the document quality algorithms (training for machine learning algorithms)
13. Previews of results, concepts associated with the results, or categories and topics and entities, e.g., people names, addresses, prices, dates, associated with the results are presented to the agent for decision making on inclusion in the result set.
14. Agent can edit the final result set via previews of the individual results, coupled with classification, concept and entity extraction from the individual results.
15. Agent can override machine-generated summaries of the results via selection of key sentences or fragments from the original document based on concepts proposed by algorithms.
16. Agent can drag and drop certain elements from pages or machine-generated suggestions into the results package to construct a result set. Examples are prices, dates, captions, figures, images, etc.
17. Agent can mark the results as ready for delivery to the user on a device of choice.
18. Agent may be re-engaged later on a clarification of the request in order to further refine the result set.
19. Each interaction of the agent in any part of the process can automatically invoke training of algorithms, e.g., machine learning classification and other algorithms, or automatically update certain databases or dictionaries, e.g., entity or concept tables.

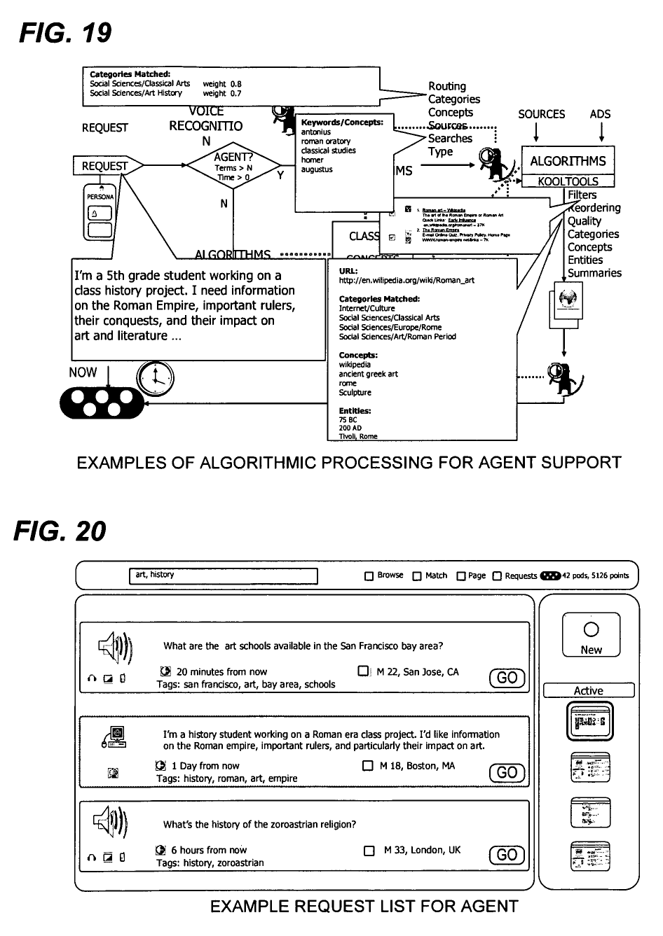

FIG. 19 shows a sample use case of a verbose request passing through the system, and examples of specific processing that occurs at each stage. Note that this only represents one embodiment, and other steps and automated algorithms can be injected into the process.

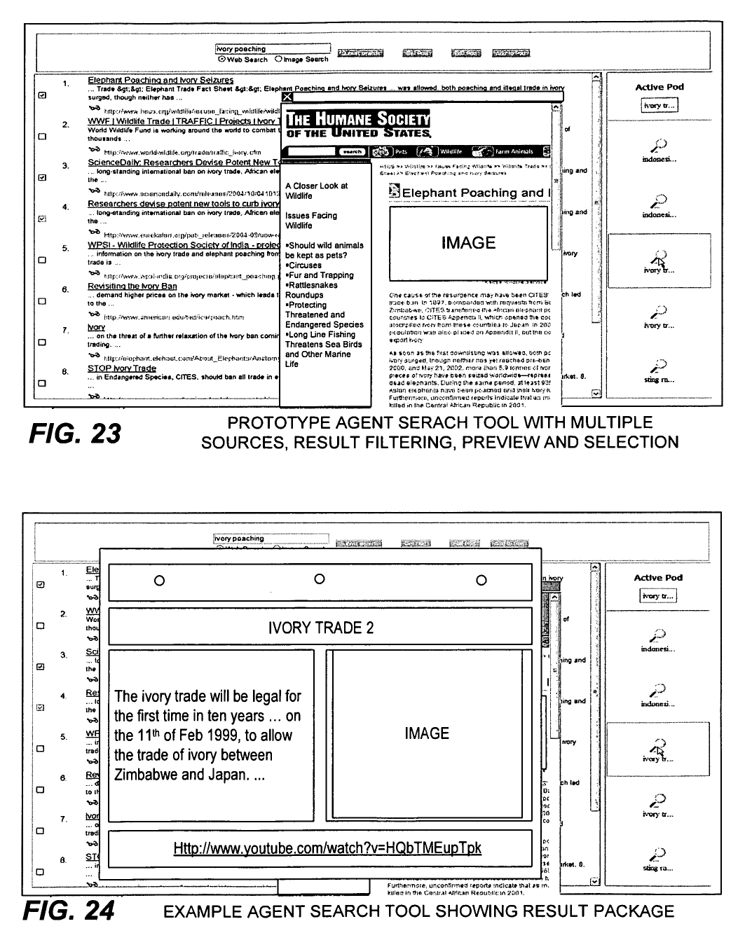

FIGS. 20-22 depict an embodiment of the agent tools. FIGS. 23 and 24 depict another embodiment of the agent tools.

It should be noted that there can be several variations of the embodiments of the invention where human judgment and intelligence are used in the search process. Additional uses of human intelligence beyond those shown herein may be used to further refine the machine algorithms via training or feedback. In particular, every interaction of human with automated suggestions can be used in training the system via feedback loops to incrementally enhance the performance of the automate algorithms. For example, rejecting certain proposed concepts can cause those concepts to be eliminated in the future for other related requests.

In other embodiments of the invention, the system and method for incorporating human insight for enhancement of search results may be used to allow humans to perform other types of tasks, not restricted to public web searches. Also, agents may have access to proprietary databases, which could be exposed to users via summaries, or via subscription fees.

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, which allows a computer system to read such computer readable information.

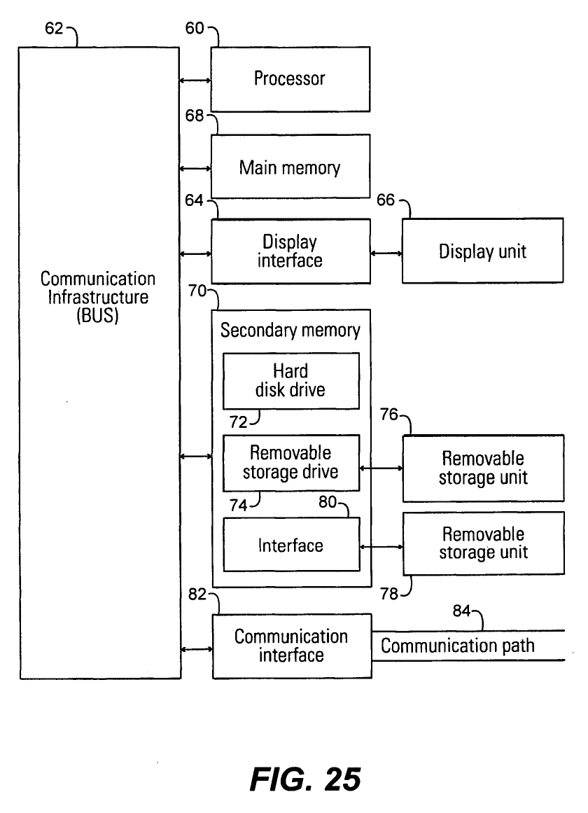

FIG. 25 is a high level block diagram showing an information processing system useful for implementing one embodiment of the present invention. The computer system includes one or more processors, such as processor 60. The processor 60 is connected to a communication infrastructure 62 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 64 that forwards graphics, text, and other data from the communication infrastructure 62 (or from a frame buffer not shown) for display on the display unit 66. The computer system also includes a main memory 68, preferably random access memory (RAM), and may also include a secondary memory 70. The secondary memory 70 may include, for example, a hard disk drive 72 and/or a removable storage drive 74, representing a floppy disk drive, a magnetic tape drive, an optical disk drive, etc. The removable storage drive 74 reads from and/or writes to a removable storage unit 76 in a manner well known to those having ordinary skill in the art. Removable storage unit 76, represents a floppy disk, a compact disc, magnetic tape, optical disk, etc. which is read by and written to by removable storage drive 74. As will be appreciated, the removable storage unit 76 includes a computer readable medium having stored therein computer software and/or data.

In alternative embodiments, the secondary memory 70 may include other similar means for allowing computer programs or other instructions to be loaded into the computer system. Such means may include, for example, a removable storage unit 78 and an interface 80. Examples of such may include a program cartridge and cartridge interface (such as that found in video game devices), a removable memory chip (such as an EPROM, or PROM) and associated socket, and other removable storage units 78 and interfaces 80 which allow software and data to be transferred from the removable storage unit 722 to the computer system.

The computer system may also include a communications interface 82. Communications interface 82 allows software and data to be transferred between the computer system and external devices. Examples of communications interface 82 may include a modem, a network interface (such as an Ethernet card), a communications port, a PCMCIA slot and card, etc. Software and data transferred via communications interface 82 are in the form of signals which may be, for example, electronic, electromagnetic, optical, or other signals capable of being received by communications interface 82. These signals are provided to communications interface 82 via a communications path (i.e., channel) 84. This channel 84 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 68 and secondary memory 70, removable storage drive 74, a hard disk installed in hard disk drive 72, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, which allows a computer to read such computer readable information.

Computer programs (also called computer control logic) are stored in main memory 68 and/or secondary memory 70. Computer programs may also be received via communications interface 82. Such computer programs, when executed, enable the computer system to perform the features of the present invention as discussed herein. In particular, the computer programs, when executed, enable the processor 60 to perform the features of the computer system. Accordingly, such computer programs represent controllers of the computer system.

In accordance with the present invention, we have disclosed systems and methods for collecting, storing, presenting and disseminating information. Those of ordinary skill in the art will appreciate that the teachings contained herein can be implemented using many kinds of software and operating systems, including, but not limited to, XML-enabled database systems such as relational databases and native XML databases as well as middleware such as query gateways, federation, and information integration. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

While the preferred embodiments of the present invention have been described in detail, it will be understood that modifications and adaptations to the embodiments shown may occur to one of ordinary skill in the art without departing from the scope of the present invention as set forth in the following claims. Thus, the scope of this invention is to be construed according to the appended claims and not limited by the specific details disclosed in the exemplary embodiments.

We claim:

1. A structured file comprising:
an information package having a plurality of frames each containing content displayable on a screen;
storage means for storing said information package;
means for transferring said information package from one location to another;
means for displaying said information package; and
user interface means for enabling a user to navigate between individual ones of said frames.

2. The structured file of claim 1 wherein some of said frames include a first type of media and other ones of said frames comprise a second media type.

3. The structured file of claim 1 wherein said first type of media includes text and said second media type is selected from the group including images, video or audio.

4. The structured file of claim 1 further comprising a search engine, wherein said structured file is generated by a single search request to said search engine.

5. The structured file of claim 4 wherein said search engine generates said structured file with further interaction via a human agent.

6. The structured file of claim 4 wherein said search engine generates said structured file using a structured source

7. The structured file of claim 6 wherein said structured source comprises a structured feed.

8. The structured file of claim 1 wherein said structured file is generated by a collaboration of multiple users.

9. The structured file of claim 1 wherein said user interface means enables a user to play the frames one after another without the need for human interaction.

10. A search engine method comprising:
generating a plurality of frames of information in response to a single search request by a user; and
packaging said frames into an object that is navigable by said user.

11. The search engine method of claim 10 wherein said frames include frames that are contain a plurality of media types.

12. The search engine method of claim 10 wherein the content of said frames is customized to said user.

13. The search engine method of claim 10 wherein said frames are stored for an extended period of time.

14. The search engine method of claim 13 wherein the content of said frames is updated periodically.

15. The search engine method of claim 13 wherein the content of said frames is updated automatically.

16. The search engine method of claim 10 further comprising displaying said frames on a mobile device.

17. The search engine method of claim 10 further comprising configuring said frames to be displayed on multiple types of devices, said multiple types of devices being selected from the group including: mobile devices, computer screens and televisions.

18. A method of organizing and displaying data comprising:
generating a package of information containing a plurality of frames, wherein each frame contains human perceptible information and wherein said frames contains a user interface to enable a user to navigate between said frames;
sending said package of information to a recipient; and
displaying said frames by said recipient.

19. The method of claim 18 further comprising receiving a query from said recipient and wherein said generating comprises finding information related to said request and preparing said frames to include said information related to said request.

20. The method of claim 18 further comprising sending said package of information to a plurality of recipients and modifying the content and appearance of said package of information depending on characteristics of the intended recipient.

21. An article of manufacture for use in a computer system tangibly embodying computer instructions executable by said computer system to perform process steps for organizing and displaying data, said process steps comprising:
generating a package of information containing a plurality of frames, wherein each frame contains human readable information and wherein said frames contains a user interface to enable a user to navigate between said frames; and
sending said package of information to a recipient;
displaying said frames by said recipient.
